(19) United States
(12) Patent Application Publication
(10) Pub. No.: US 2020/0310408 A1
(43) Pub. Date: Oct. 1, 2020

(54) UNMANNED AERIAL VEHICLE SYSTEM PROVIDING SECURE COMMUNICATION, DATA TRANSFER, AND TRACKING

(71) Applicants: Todd Carper, Sunnyvale, CA (US); Egbert Oostburg, Chula Vista, CA (US)

(72) Inventors: Todd Carper, Sunnyvale, CA (US); Egbert Oostburg, Chula Vista, CA (US)

(21) Appl. No.: 16/452,260

(22) Filed: Jun. 25, 2019

Related U.S. Application Data
(60) Provisional application No. 62/689,349, filed on Jun. 25, 2018.

(51) Int. Cl. G05D 1/00; H04B 1/3822; H04B 7/185; G08G 5/00; G06K 19/07; H04L 9/30; H04W 12/04; G06K 7/10; B64C 39/02; G05D 1/10; G01S 19/42

(52) U.S. Cl. CPC G05D 1/0016; G05D 1/0022; H04B 7/18506; G08G 5/0039; G08G 5/0026; G06K 19/0723; H04L 9/30; H04W 12/04; G06K 7/10366; B64C 39/024; G05D 1/101; G01S 19/42; B64C 2201/027; B64C 2201/14; H04B 1/3822

(57) ABSTRACT

A system provides secure communication, data generation and data transfer, and tracking between a drone and a plurality of interactive entities. One entity comprises a base station including a transmitter and a receiver tuned to communicate with a drone having an RFID tag. The drone tag stores information on flight plan parameters and reports condition-responsive information. From a multitude of data fields, unique data sets are created in correspondence with requirements of stakeholders. Drone tags including encryption, communication, and processing circuitry which are operated to interact with individual drone operators communicates with specific drones, subscribers, and with outside agencies on behalf of subscribers. Data at rest may be encrypted or decrypted. RFID tags for inclusion in drone electronics include microprocessors capable of encryption and decryption. interacts with internal components, such as sensors and databases.

### CROSS REFERENCE TO RELATED APPLICATIONS

This patent application claims priority to U.S. Provisional Patent Application Ser. No. 62/689,349 filed Jun. 25, 2018, which is incorporated herein by reference in its entirety.

### FIELD OF TECHNOLOGY

The present subject matter relates to a system and method for secure communications and coordination with unmanned aerial vehicles and various stakeholders in the system.

### BACKGROUND

Unmanned aerial vehicle, drone, systems have many stakeholders, each requiring differing interactions with the system. Drone operating companies need to instruct and track drone operations. Drone manufacturers may be able to prepare drones for operation in many respects prior to deployment by drone owners. Various other stakeholders have needs that are not being met by prior art systems. Insurance companies do not readily track drone operations. In many scenarios, administrative and enforcement agencies have difficulty maintaining accountability of drone and is the case we operators.

A stakeholder is a party that has an interest in a company or system or regime and can either affect or be affected by the business. Stakeholders can affect or be affected by the organization's actions, objectives and policies. Some examples of key stakeholders in the drone community are operators, owners, employees, federal, state, and local governmental agencies, shareholders, suppliers, service providers, and the community from which the regime draws its resources and receives its services. Stakeholders may be resolved into categories of users, governance, influencers, and providers.

The needs created by the exploding volume of drone flights have exceeded the capabilities of the prior art in many areas. These areas include establishing accountability of drone operators for compliance with airspace regulations, informing drone operators of restrictions in the drones airspace, secure communications, gathering information via sensors, and facilitating proper regulatory registrations and updates. There is a need for providing solutions that must meet the constraints inherent in aerial vehicles.

Noncompliance with airspace regulations causes dangerous incidents. In the case of many harmful or potentially disastrous incidents, authorities have had great difficulty in identifying the drone and the operator to whom the drone is registered. There is necessity to hold drone operators accountable for noncompliance with airspace regulations. According to the United States Federal Aviation Administration (FAA) reports of drones flying improperly or getting too close to other aircraft averaged 159 incidents per month from February through September 2016. Researchers at Virginia Tech's College of Engineering demonstrated in 2015 that an eight-pound quadcopter drone could rip apart a nine-foot-diameter engine in less than 1/200th of a second. In 2017, the FAA conducted a study based on computerized models. The study concluded that drones would cause more damage than birds of similar size because they contain metal parts. Significant damage to windshields, wings and tail surfaces was possible.

Stakeholders include companies that insure drone operations. They need actuarial data for calculating premiums. Tracking drone operations allows insurers to calculate risks. Therefore, unsafe operators would contribute to the cost of harm caused by their actions.

The FAA maintains restrictions for operation within a given airspace. Some regulations apply in general. Other regulations apply to airspace in the vicinity of special locations such as military bases and tall buildings. The restrictions are analogous to automobile regulations. The FAA provides regulations. Updates to regulations may comprise restrictions in view of special events. Updates could also comprise an exemption from a particular restriction. Beacons may provide information to drones on localized restrictions in order to update the drones' stored data.

As of 2016, the FAA said it wanted to modify normal regulatory requirements so it could more quickly adopt an automated system for approving low-level drone flights in restricted areas. The FAA receives thousands of requests per month for special flight authorizations. The agency has created what it calls the Low Altitude Authorization and Notification Capability, which takes five minutes for approval via computer instead of months. Authorization could be transmitted to a drone in real time and inform the drone operator of an exemption from airspace regulations.

Secure communications are a necessity. “Hacking” of drone communications could cause immense damage. Robustness of prior art systems could be improved. Drones have provided video and other data. Unexpected new data gathering capabilities via sensors are possible.

Drone registration is commonly achieved through communications by an individual directly with the FAA. It would be desirable to have a streamlined process for creating and updating registrations.

U.S. Pat. No. 9,646,502 discloses a system in which one of a plurality of UAVs may transmit its own identifying certificates and receive one or more identifying certificates from one or more individual UAVs operating in a common airspace. An identifying certificate may include a unique identification number associated with the UAV, such as a serial number; the owner and/or operator of the UAV, the UAV's license and issuer; validity dates, and a public key fingerprint. The UAV must operate in a mesh network and does not interact directly with a beacon. No manner of entering or updating identification information is disclosed.

United States Published Patent Application No. 20170011637 discloses a method and apparatus for generating and outputting dynamic variance reports for deviations of vehicle operations from programmed vehicle operations. The dynamic variance reports enable a vehicle operations scheduler to understand trends, patterns, or the like in variances between planned vehicle operations and actual vehicle operations. A complete report is not provided to a third-party used for processing by the third-party user's own algorithms.

United States Published Patent Application No. 20180088206 discloses methods and apparatus for accurately tracking a package and encrypting keys. Key management is achieved by transmission of encrypted signals. However, means are not disclosed for providing an encrypted memory for data at rest.

United States Published Patent Application No. 20180144124 discloses a path manager that exercises control by transmitting messages to the client that establishes privileges to systems paths through an authentication protocol. However, real time updating of privileges is not disclosed.

U.S. Pat. No. 9,984,260 discloses an IC tag issuing apparatus for writing identification data to IC tags, the IC tags arranged in multiple rows aligned as an IC tag continuous body. An IC tags issuing apparatus including second antenna units is arranged to face each row of the IC tags arranged in multiple rows. Data is not downloaded from a secure network.

### SUMMARY

Briefly stated, in accordance with the present subject matter, a novel system performing novel methods. A base station server commands and coordinates communication with and coordination between operations and requirements of various stakeholders. Some stakeholders need to command and regulate drone operations. Others need various forms of current and historical data of drone performance. Others may need to monitor drone operations in view of physical or legal constraints. The base station server provides identity and encryption tag information to drones and receives data from the drones. Data in transit between the drone and the base station is encrypted. Data at rest may be encrypted or decrypted. RFID tags for inclusion in drone electronics include microprocessors capable of encryption and decryption. The base station server may issue blocks of drone tag IDs, which a manufacturer may assign to individual drones. X-Y-Z coordinates are established for an initial drone position. As the drone is in flight, coordinates are updated by data from accelerometers. Further, storage of flight information comprises storing encrypted data. Providing dynamic positioning data is done without requiring the use of GPS. A record of the drones' flight path and velocities at selected points on the flight path are generated. Parameter sensors placed in the drone provide further data. The present system allows for previously unavailable dynamic control of operations and for selectable fashioning of data for various stakeholder requirements. The system provides hitherto unavailable flexibility and adaptability to meet the needs of all stakeholders in the drone community.

The present subject matter utilizes drone tags in a system to provide information not previously obtainable. Drone tags including encryption, communication, and processing circuitry are operated to interact with individual drone operators communicating with specific drones, subscribers, and with outside agencies on behalf of subscribers. One group of services is provided for a respective class of subscribers.

A consolidated information service is provided to subscribers. These subscribers are provided with usage information and flight records. These subscribers may use their own algorithms and data processing methods to derive information relevant to their interests. Another class of subscribers may comprise electronics manufacturers and drone assemblers. Preprogrammed blocks of identification numbers may be provided by a drone service company so that a subscriber may be preregistered with a services company when it receives delivery of new drones.

### BRIEF DESCRIPTION OF THE DRAWINGS

FIG. 1 FIG. 1 is a diagram representing a system according to the present subject matter;

FIG. 2 is a perspective view of an exemplary drone;

FIG. 3 is a block diagram of operating hardware;

FIG. 4 is a block diagram of a drone tag; FIG. 5 is a block diagram illustrating formation of data fields generated by or received by the drone.;

FIG. 6 is a block diagram illustrating key management in order to enable encrypted communications.;

FIG. 7 is a block diagram of a system reporting messages to subscribers.;

FIG. 8 is a diagram of data structures used by the portable interactive device or cloud database to interact with the system;

FIG. 9 is a table illustrating data flow in the steps of set up and data collection;

FIG. 10 illustrates the path of data in use;

FIG. 11 comprises columns corresponding to data location; and

FIG. 12 is a flow chart which illustrates operation of the present system.

### DETAILED DESCRIPTION

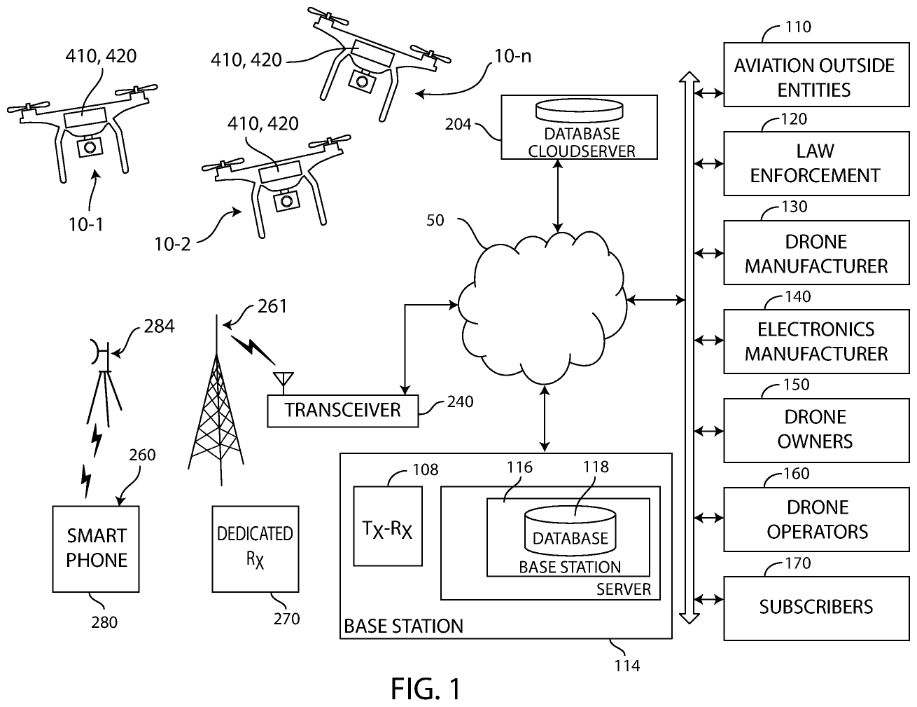

FIG. 1 is a diagram representing a system 1 according to the present subject matter. The present subject matter provides services and information to provide sets of data to various stakeholders 20 in operations of drones 10. Drones collectively or individually are referred to as drones 10. Specific drones are denoted as 10-n, where n is an integer. Each interacting element in the system 1, whether a company, individual, or an apparatus is referred to as an entity 30. Many different forms of coordination and communication may be utilized. In the present illustration, operations and infrastructure are provided through a drone services company 100. The stakeholders 20 will generally communicate over the Internet 50. Stakeholders 20 comprise entities 30. Entities may also communicate via radio signals, cell phone, or other means as further described below.

Types of stakeholders include drone service companies 100, governmental aviation control authorities 110, government law enforcement authorities 120, drone manufacturers 130, drone electronics manufacturers 140, drone owners 150, drone operators 160, and subscribers 170 One type of subscriber is an insurance company that needs to know how the drone operator 160 performs its tasks and also needs recorded evidence in the event of a drone mishap. Another type of subscriber is a drone owner 150 who wishes to have a record of the use of the drone including flight paths and conditions of operation.

Drone services companies 100 will customarily be housed in a base station 114. The base station 114 comprises a base station server 116 and a radio frequency communications unit 108. The base station server 116 comprises a base station server database 118. Subscribers include individuals or organizations that have a direct interest in drone operations.

The interactions and data to be provided may be a function of the requirements of each stakeholder 20. The present subject matter allows customization and modification of data inputs and outputs to meet the needs of various stakeholders 20. Selected forms of interaction for various stakeholders include:

service companies 100—operate a base station 114 to provide communication between a drone operating company and one or more drones, coordination and communication between selected stake holders, maintaining infrastructure, providing and maintaining a server to process data and control operation, providing and maintaining software to operate the system and components subsystems, and creating sets of information to serve unique needs of different stakeholders governmental aviation control authorities 110—obtain information on flight paths of drones, observe compliance with regulations, authorize or deny requested exceptions to airspace regulations

government law enforcement authorities 120—monitor flight paths of drones and enforce boundaries of restricted areas

drone manufacturers 130—provide drones with capability of carrying unique identification data, provide mechanical coupling between drones and drone electronics

drone electronics manufacturers 140—provide RFID tags and printed circuit boards for operation in accordance with system protocols

drone owners 150—track inventory of drones and collect evidence of actions by drone operators

drone operators 160—program operation of drones, maintain real time contact with drones and provide dynamic update

subscribers 170—obtain sets of data including actionable information to enable meaningful interaction with other stakeholders

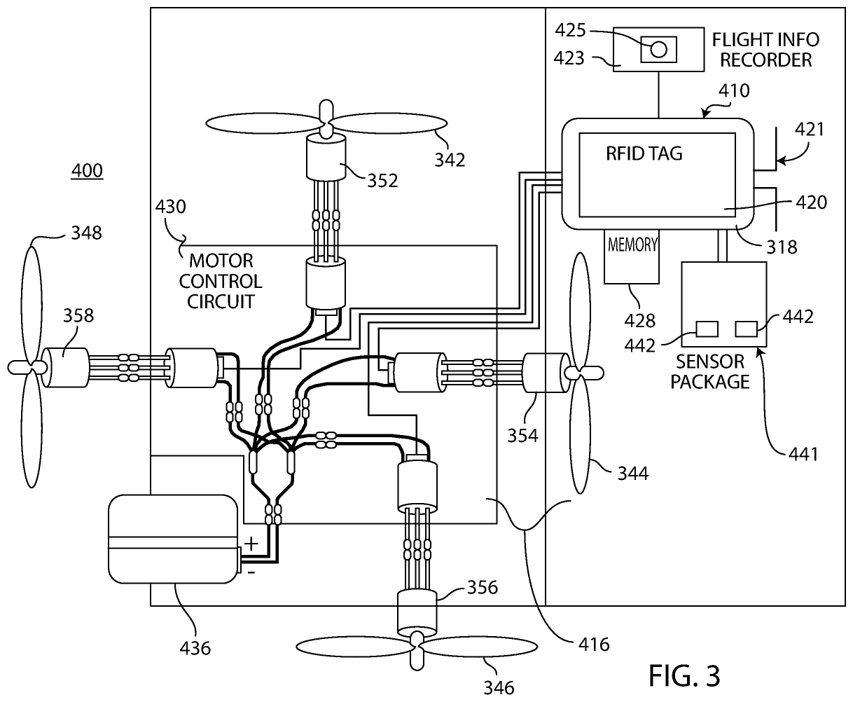

Further forms of communications are used to enable interaction of entities in the system 1. A transceiver 240 couples entities to a beacon 261. A dedicated receiver 270 is provided for receiving data. The dedicated receiver 270 may be a standalone receiver or may be included in one or more of the entities discussed above. A portable interactive device 260 may also be used for communications. The typical portable interactive device 260 is a smart phone 280. The smart phone 280 communicates via a cell tower 284. The unique interactions provided by the present subject matter are discussed below. The drone 10 is operated in response to communications with entities 30 via a drone tag 410 described with respect to FIG. 3 below. The drone tag 410 comprises elements enabling unique interactions with the entities 30.

This system 1 provides secure communication, data generation and data transfer, monitoring, and tracking between the drone 10 and the large number of entities 30 as required to fill predefined purposes. A first function is to provide secure communication between base station 114 and the drone 10. The base station 114 includes a transmitter-receiver 108. The transmitter-receiver 108 is tuned to communicate with a frequency to which a transceiver in the drone 10 is set. Other entities are set to provide and to respond to frequencies of entities 30 with which they will interact. One interaction comprises providing identity information for each drone 10. Identity information may be set up by the drone services company 100 to provide data formatted for use by each drone 10. The drone services company 100 may supply blocks of identity numbers to drone manufacturers 130 in order to allow the drone manufacturers 130 to provide drones 10 which are pre-identified. The drone services company 100 issues blocks of drone tag IDs from the base station server 116. A manufacturer 130 may assign individual ID tags to individual respective drones 10. A verification routine is provided between the base station server 116 and the RFID drone tag 410 (FIG. 3).

A cloud server 204 is accessible via the Internet 50 to all entities 30. The cloud server 204 provides for cloud-based services and cloud-based storage.

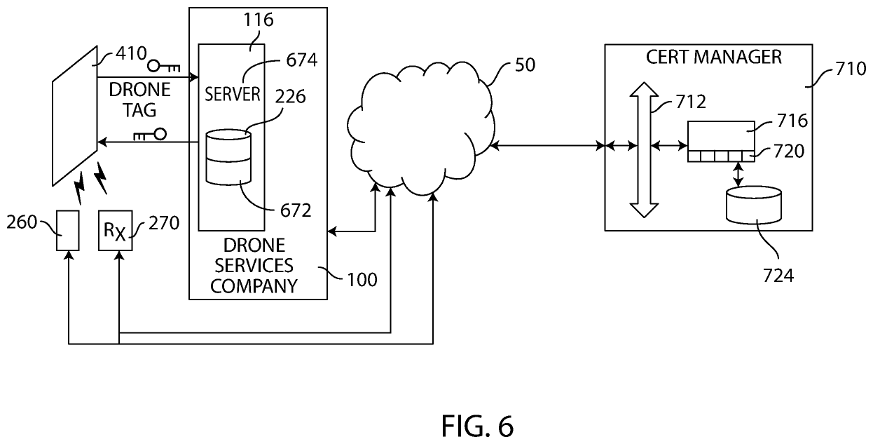

The base station server 116 performs data processing, storage of information to be transmitted, and storage of information to be received. One range of data comprises identity information. Each drone participating in the system 1 has a drone identifier stored in a memory location in the base station server 116. Further, encryption information is provided for data in motion. The base station server 116 comprises a database 118 including locations storing encryption tag information. Each drone will have circuitry for generating a key and transmitting the key to the base station server 116. Encryption tag information includes a key. The key may be generated by the drone 10 in a manner further described below with respect to FIG. 6.

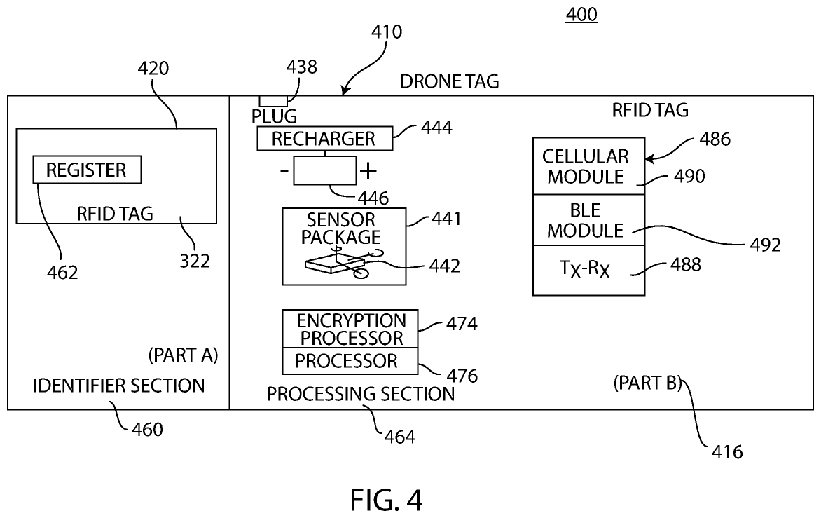

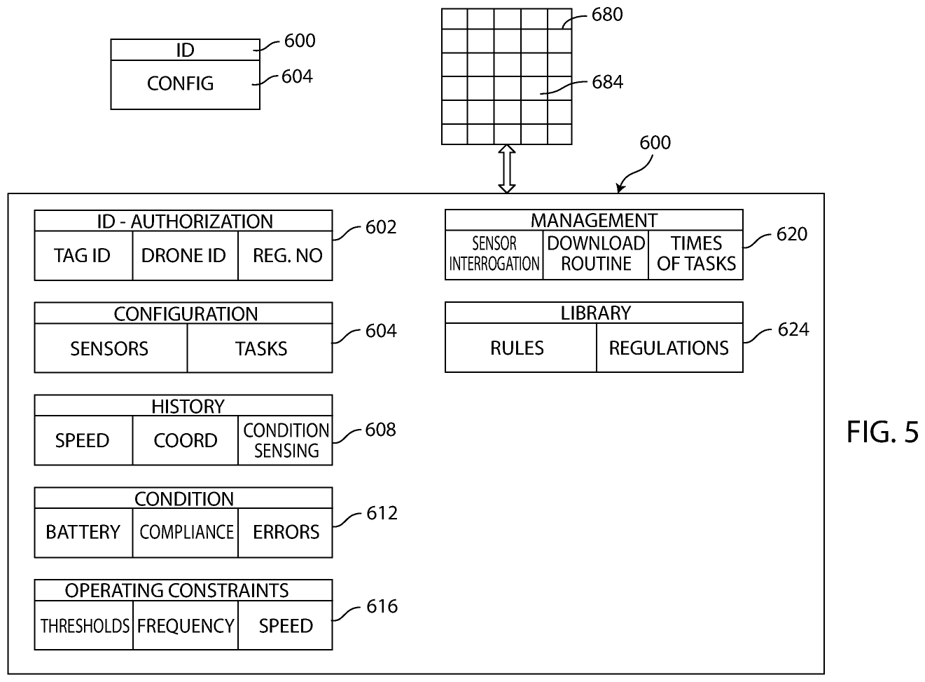

A drone tag 410 is mounted in the drone 10. The drone tag 410 comprises an RFID tag 420 (FIG. 3). As further described with respect to FIG. 4, the RFID tag 420 includes an identifier section, processing section, and identity register, and encryption processor. FIG. 4 also discloses a transmitter and receiver module 488 included in operating hardware 400. The operating hardware 400 comprises circuitry for commanding and performing all functions of the drone. The drone tag 410 further comprises condition-responsive sensors providing outputs that may both be stored, coupled for drone control, and included in data fields provided to subscribers 170 or other entities 30. Groups of subscribers are established, with at least one class of subscribers 170. Each subscriber 170 is assigned to at least one class. Each drone tag 410 is associated with a corresponding subscriber 170. The base station 114 receives flight data from a drone 10 and transmits data to the drone 10 from the base station. The base station server 116 uses an input application program interface (API) to provide data via the API to each subscriber. The base station server 116 reports to subscribers 170 selective sets of flight information, and also transmits flight commands to a drone associated with a particular subscriber. RFID drone tag 420, also referred to as a drone tag 420, but which differs from drone tag 410, uses its microprocessors and memory to form a data package of information stored in the drone tag 410. The drone tag 410 reports data including ID, coordinates, and condition-responsive information to the base station 114 in response to commands. A flight plan stored in said RFID drone tag 420 is selectively updated.

The drone tag memory includes storage for constraints, such as a flight plan, company operation policies, and other operating considerations. in the RFID drone tag 420 and selectively updating the flight plan. The method performed by the system comprises communicating from the base station 114 to a plurality of individual drone operators 160 each associated with a drone ID tag, receiving requests from the operators for permission to change flight parameters, forwarding the requests to a responsible authority, and returning any authorization to an operator. Forwarding the request, usually by the base station 114, comprises translating the request into a format for receipt by a cognizant governmental authority and monitoring communication and forwarding a response to the drone operator and wherein forwarding an authorization comprises sending flight commands to the drone. The base station server interacts with a plurality of drone operating companies to provide real time flight information to each drone operating company for use by said drone operating company in accordance with its own algorithms.

The drone tag 410 receives data and transmits the data via an encryption processor 474 (FIG. 4). Data at rest may be stored in encrypted form. Additionally, data is transmitted in encrypted form from the drone 10 to the base station server 116. The encryption processor 474 transmits a public key to the base station server.

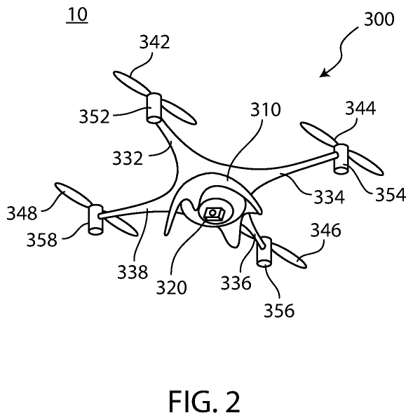

FIG. 2 is a perspective view of an exemplary drone 10. Particular drone structure will vary in accordance with application in which the drone 10 will be used. Applications include aerial observation and making deliveries. The following teachings are applicable to virtually all drones 10 except where drone structure and application is not compatible.

In the present illustration, the drone 10 comprises a quadricopter 300. The quadricopter 300 comprises a central body 310 which includes operating hardware 400 further described with respect to FIG. 3 below. The central body 310 also includes a mechanical module 320. The mechanical module 320 includes apparatus provided for functioning of the drone. This apparatus could include aerial photography devices or delivery bays including product release apparatus. First, second, third, and fourth radial arms 332, 334, 336, and 338 extend from the central body 310. These arms respectively support first, second, third, and fourth propellers 342, 344, 346, and 348. The propellers are respectively driven by first, second, third, and fourth electric motors 352, 354, 356, and 358. Drones may be comprised of fewer or additional motors. The motors may be oriented in varying manners.

FIG. 3 is a block diagram of the operating hardware 400. The operating hardware 400 is housed in the central body 310 (FIG. 2). Components of the operating hardware 400 comprise elements for receiving data and commands to make the drone 10 perform as desired. The operating hardware 400 also produces data and other signals selectively providable to entities 30. The operating hardware 400 includes the drone tag 410. The operating hardware 400 is formed on a printed circuit board 416. Traditionally, printed circuit boards have comprised discrete components on a fiberglass reinforced epoxy substrate. It is now common to form complex circuits on polymer film. For purposes of the present description, “printed circuit board” refers to circuitry on a rigid substrate or a circuit embodied in a flexible thin plastic substrate having adhesive on one side.

The drone tag 410 comprises an RFID tag 420 and further circuitry. Novel interactions in the printed circuit board 416 include data exchange between the sensor package 440 and the RFID tag 420. The sensor package 440 comprises accelerometers 442 which sense the motion of the drone 10. The system illustrates that the drone tag 410 comprises a location memory in a drone tag 428 for storing initial GPS coordinates, and all other current and preloaded data. The accelerometers 442 are condition-responsive sensors which provide data to the RFID tag 420 to update current position of the drone 10 in said drone memory 428. In this manner, updated information may be provided without the necessity of a GPS signal. Consequently, position information may be maintained at all times even if the GPS signal is lost.

The printed circuit board 416 includes a motor control circuit 430. A battery 436 is connected to the motor control circuit 430 to provide power for the electric motors. The battery 436 may also power other elements of the drone tag 410, as further illustrated in FIG. 4. A sensor package 440 is provided including sensors to support particular tasks. For example, the censor package 440 may comprise accelerometers 442. The accelerometers 442 can update changes in the location of the drone 10. Therefore, an initial position of the drone 10 is provided by a GPS signal. An antenna 421 receives signals from various entities, usually via the drone services company 100 (FIG. 1). The antenna 421 also transmits data from the drone tag 410. The drone tag 410 records flight information in a flight information recorder 423 storing preselected parameters for availability to external entities. The information recorder 423 comprises a timing circuit 425 coupled to initiate transmission of the flight information at at least one time during a drone flight. Data is uploaded at a preselected time or times. Usually it is uploaded to the base station server 116. A more direct interaction with the drone 10 may be provided by enabling communications with the portable interactive device 260 (FIG. 1). A drone operator may communicate directly to the drone 10 in order to exchange information prior to or at the end of a drone 10 flight.

FIG. 4 is a block diagram of the drone tag 400. A recharger 434 may be coupled to the battery 436. A plug 438 is provided for coupling the recharger to an external source. The RFID tag 420 comprises an identifier section 460 and a processing section 464. The resolution of the RFID tag 420 into two sections is made for the purposes of description. In practice, the RFID tag 420 is not manufactured in discrete sections. The identifier section 460 comprises a register 462. The register 462 may store a data field uniquely identifying the drone 10. The register 462 may also be writable to have additional permanent or temporary data stored therein.

The processing section 464 comprises an integrated circuit performing many functions. The components within the processing section 464 are illustrated as discrete components for purposes of description. Each processor comprises a microprocessor. Each microprocessor comprises memory. A processor 470 comprises a secure, encryption processor 474 and an open processor 476. The encryption processor 474 maintains encryption keys. The antenna 421 may be formed by vapor deposition. The circuit board 416 translates control signals to the motor control circuit 430. Power is provided from a battery 446. The battery 446 is coupled to the motor control circuit 430 and to the circuit board 416. A sensor package 441 provides condition-responsive information to the processing section 464. The sensor package 441 measures current parameters and updates condition-responsive data stored in the drone tag 410 during flight. Accelerometers 442 may be provided in the sensor package 441 and may update the position of the drone 10 in comparison to an initial position measured by GPS. An updated signal indicative of the new position is sent to the processor 476 for storage and for transmission to an entity 30. Transmission may be performed in response to a stored program in the processor 476. Transmission may also be performed in response to a query from an entity 30. Additional transducers and timers may also be provided.

The drone 10 communicates to the outside world via a communications module 486. Radio frequency communication is provided by a transceiver 488. Certain exchanges may be provided via modules 490 and 492 that accommodate cellular telephone signals and Bluetooth signals respectively, generally when the drone 10 is at or near a takeoff or landing location. The cellular module 490 allows communication with entities using portable interactive devices such as cell phones. The Bluetooth module 492 is preferably a Bluetooth Low Energy (BLE) module in order to reduce power consumption and yet maintain a similar communications range. The BLE protocol transmits small packets as compared to Bluetooth Classic. In accordance with the present subject matter, commands and information are arranged so that the high bandwidth capability of Bluetooth Classics is not required.

FIG. 5 is a block diagram illustrating formation of data fields 600 generated by or received by the drone 10. Data packages comprise selected sets of data fields. These fields may comprise information stored in the drone tag 410. The drone tag 410 transmits data to the base station server 116. The data fields 600 hold drone information and are used by the drone tag 410 to define, execute, communicate, and report actions of the drone 10. Field 602 contains the unique identity of the drone 10, e.g., serial number. Field 602 may also include a registration number which identifies the drone 10 to a regulating agency such as the FAA. Field 604 holds configuration information. Configuration information includes the task that the drone 10 is to perform. The configuration information further comprises identities of sensors in the sensor package 441 (FIG. 4). Field 608 comprises operation history. Operation history includes the flight record of the drone 10 including the positions over time of the drone 10 and the speed at each position. The position and speed are provided to a preselected granularity.

Field 612 may be provided to record the status and condition at various times. Status may include battery level, motion or non-motion, non-compliance with operating constraints and other conditions which may be selected by drone operators or programmers. Operating constraints may be stored in field 616. Operating constraints include maximum permissible speed, maximum or minimum altitude, and allowable distance from other objects, whether airborne or stationary. Field 620 comprises control management data. Data management is one function. The sensor package 441 is queried at a preselected rate. Higher frequency produces greater granularity. Lower frequency increases battery life. The control may also determine whether groups of data are transmitted at successive times or whether all information is stored and downloaded when a flight is complete. Management also comprises selecting the time when the drone 10 begins to gather data. For example, data gathering may be postponed until the time when the drone 10 reaches a preselected altitude.

A library field 624 may contain rules for operation. Rules for operation may be set by the drone owner 150, the drone services company 100 or other entities. The rules may include maximum length of time operation, permitted or restricted areas of operation, protocols for various functions and limits for various parameters such as speed airborne time. The library 624 may also comprise a regulations section to operating constraints or notice requirements of jurisdictions having cognizance over the drone operation. The library 624 may inform the operation field 616 of values of parameters to which to compare drone operation.

Fields are provided to each entity 30 as needed. A selection circuit 680 may query each of the fields 604 preselected data. The system comprises a selection circuit 680 for resolving data received from said drone tag 410 into separate fields of drone information and selection circuit 680. The selection circuit 680 comprises a matrix 684 defining fields of drone information for an entity. One dimension of the matrix 684 identifies entities. A second dimension identifies information fields. Selection of one entity 30 will define a set of information fields to be provided to or from the selected entity 30. For example, the entity comprising the operating services company 100 will require a great deal of information. This includes virtually all of the fields 602 through 624. A subscriber 170 comprising an insurance company may require history data and compliance with regulations data. A local governmental authority 110 and may require location data to determine if the drone 10 is within the jurisdiction of the local governmental authority 110 and if so, what results need to be generated. For example, the local governmental authority 110 could impose a fee on a drone operator for each takeoff and each landing within the jurisdiction of the local governmental authority 110. In one embodiment, all data is provided to the base station server 116. The matrix 684 is programmed into the database server 116 so that each entity is provided with access to required data. Each entity is enabled to receive selected fields of data. For purposes of description, the nodes at which the data is connected to a respective entity is referred to as an access port. The access ports deliver respective sets of fields to appropriate subscribers 170 and other entities 30.

FIG. 6 is a block diagram illustrating key management in order to enable encrypted communications. The system 1 may use either symmetrical or asymmetrical encryption. In many embodiments symmetric encryption may be preferred since data structures are simpler than in asymmetrical encryption. In the present illustration, symmetrical encryption is provided. The drone tag 410 generates a key pair utilizing a symmetric encryption protocol. The drone tag 410 then exports a public key to the base station server 116. The transmission to the base station server 116 is made by radio frequency transmission to the transmit-receive module 108 (FIG. 1) or by transmission to the dedicated receiver 270 (FIG. 1) and coupling via the Internet 50.

A certification manager server 710 is used to perform an authentication routine and to generate certification criteria for the key pair in the drone tag 410. The certification manager server 710 can be included in the base station 114 or could comprise an outside cybersecurity service. The certification manager server 710 maybe coupled to the base station server 116 via the Internet 50. A data bus 712 couples data to and from a certification processor 716 which reads to and writes from a register 720. Data is exchanged between the certification processor 716 and a certification database 724. The base station server database 118 comprises a key data repository 722. The base station server 116 also acts as a key server 674.

In operation, the drone tag 410 imports a drone services company 100′s public key. The information exchanged between the certification manager server 710 and the drone tag 410 is stored in encrypted form and transmitted in encrypted form. Therefore, the private key is inaccessible except to an authorized user. It is not possible to extract or insert a private key into the data stream. The secure processor 474 (FIG. 4) in the drone tag 410 preferably comprises a secure application specific integrated circuit (ASIC). One such ASIC is the NXP SMART® MX made by NXP Semiconductors N.V. Any firmware updates must use a secure firmware update mechanism. Alternatively, updates may be prohibited. New firmware may be provided in a replacement disposable ASIC.

Encrypted stored data in the drone tag 410 is transmitted in encrypted form to the key data repository 672. The data is not decrypted. It is stored in encrypted form. Therefore, if a hacker gains entry into the drone tag 410 or the key data repository 672, the hacker will only obtain encrypted data. Each drone tag 410 contains encrypted keys. The key server 674 manages symmetrical encryption keys and their transmission to subscribers 170.

In operation, two card keys are required to start data exchanges. The drone tag 410 confirms authentication with the base station server 116 . This arrangement provides for secure performance. More specifically, the drone tag 410 records flight information and then uploads data to the portable interactive device 260 at the end of a drone 10 flight. The drone tag 410 may also send frequent location updates during a flight. Communication with entities outside of the drone can be made via a portable interactive device before and after a drone flight. Data encrypted in the drone tag 410 may be transmitted to and read by the portable interactive device 260, e.g., a cell phone 280, or by the dedicated receiver 270. Data is transmitted via the Internet 50 to the drone services company 100. Authentication management to provide certification of a drone 10 by its identity is incorporated in the drone tag 410.

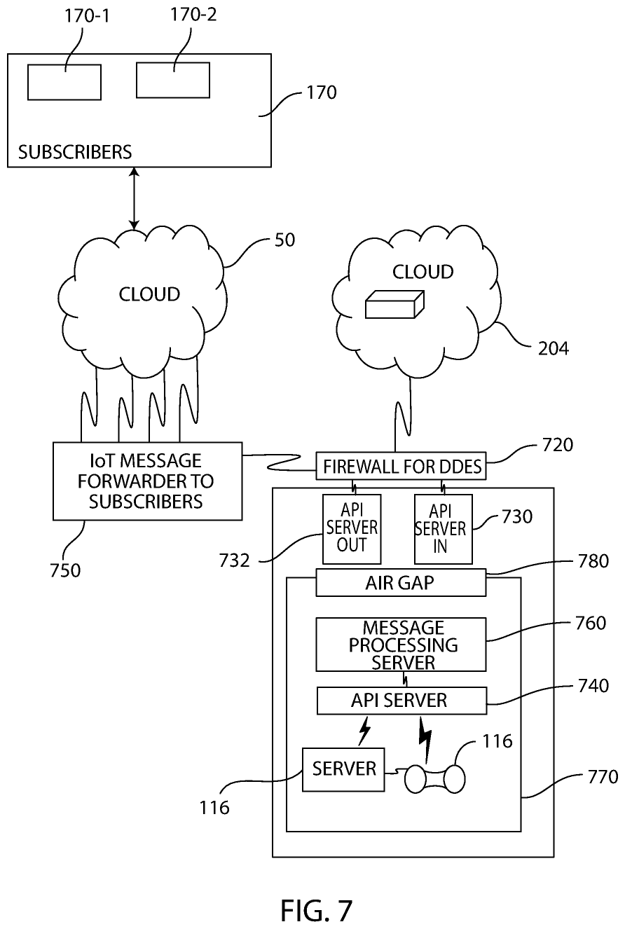

FIG. 7 is a block diagram of a system reporting messages to subscribers 170 and interaction of application program interfaces in the present system. The subscribers 170 receive data via the Internet 50 from an Internet of Things (IoT) message forwarder 750. Each subscriber 170 is provided with an address. To reach a particular subscriber 170, a message is forwarded to its respective address. Each subscriber 170 can decrypt secure messages for which it has the key.

There are many forms of subscribers 170. Subscriber 170-1 is a drone delivery company that will keep track of the flights executed by its drone 10. Subscriber 170-2 is an insurance company. Using its own algorithms, the subscriber 170-2 uses the actual data to calculate the risk presented by the drone operator.

The IoT message forwarder 750 receives data via a firewall 720 of the drone services company 100. Data is provided to and from the firewall 720 via an API (application program interface). An input API servicer interface 730 receives input data and an API output servicer interface 732 provides output data. The API servicer interface 730 and 732 interact with an API servicer 740 in a non-routable network 770. A non-routable network 770 uses a communications protocol that contains only a device address and not a network address and provides network segregation. It does not incorporate an addressing scheme for sending data from one network to another. Network segregation is a common security technique to prevent security issues in one network affecting another. One example of a non-routable protocol is NetBIOS.

The drone services company 100 including base station server 116 exchanges information with the API servicer 740. A message processing server 760 communicates with the API servicer 740. An air gap 780 separates the non-routable network 770 from the API servicer interfaces 730 and 732.

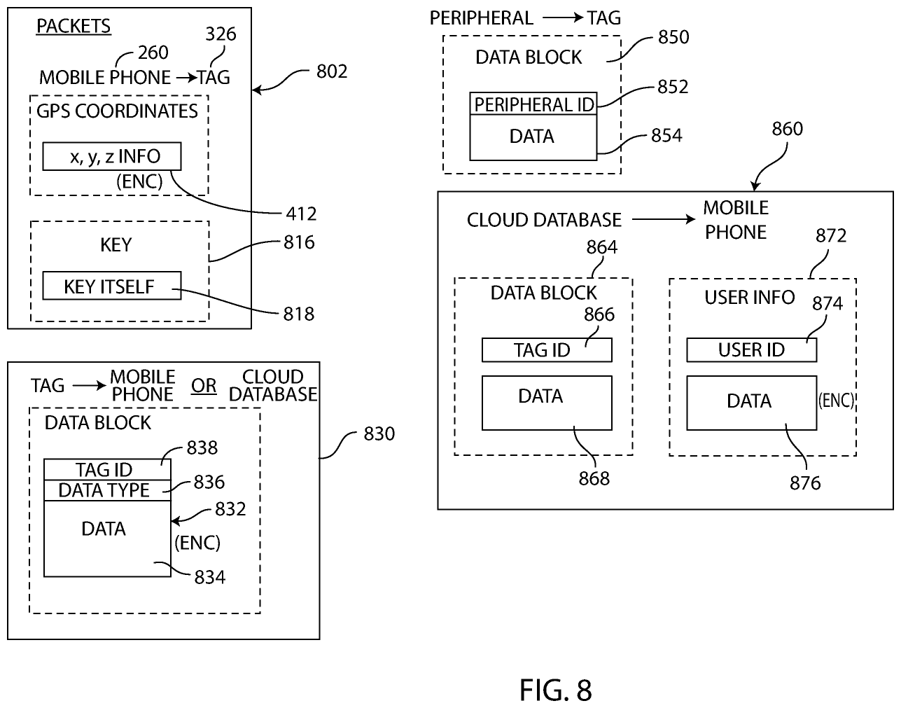

FIG. 8 is a diagram of data structures used by the portable interactive device 260 or cloud server 204 to interact with the system 1. A first field group 802 illustrates packets delivered from the portable interactive device 260 to the drone tag 410. GPS field 810 comprises a packet containing initial X-Y-Z position information obtained from a GPS System and delivered to the drone tag memory 428. Key field 816 contains an encryption key 818.

A second field group 830 describes structure of a data packet 832. A data block 834 is followed by a data type block 836 along with a drone tag identification 838. A third field group 850 provides identity 852 of a peripheral device providing an information data block 854. A fourth field group 860 identifies data structures for communicating from the cloud data base to the portable interactive device 260. Cloud data block 864 includes a tag ID 866 and data 868. User information data block 872 includes a user ID field 874 and a data field 876.

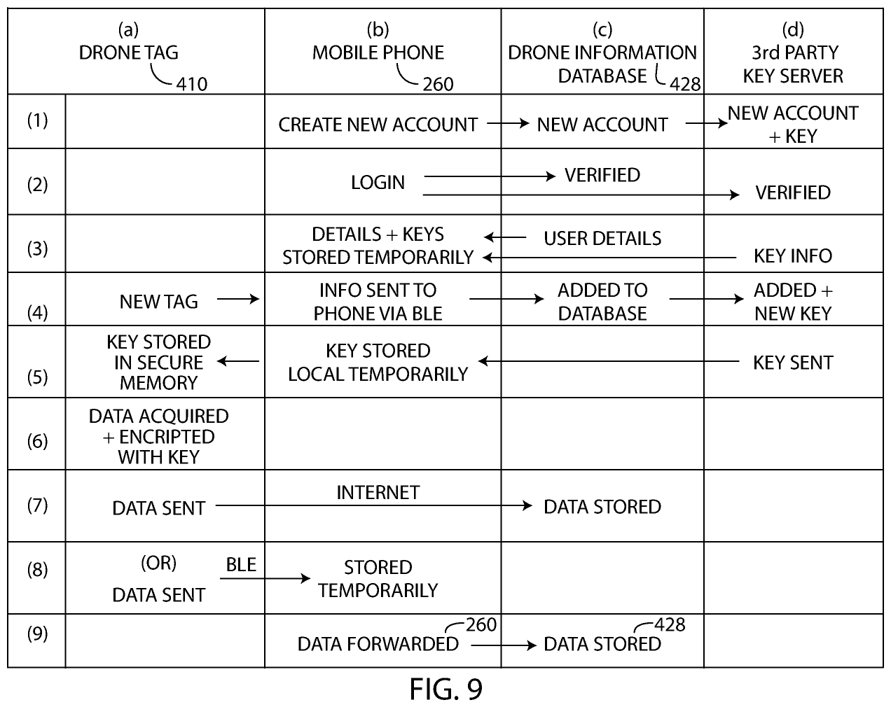

FIG. 9 is a table illustrating data flow in the steps of set up and data collection. Each column in FIG. 9 represents a data location. Each row represents data flow. The data location represented in each respective column is: (a) drone tag 410; (b) portable interactive device 260; (c) drone information database, e.g., the drone tag processor memory 428: and (d) a third-party key server, e.g., the key server 674 (FIG. 5). FIG. 9 comprises rows dealing with the following types of data respectively: (1) creation of a new user account; (2) login by the new user; (3) loading of user details; (4) entering a new tag in the system; (5) storing a key in secure memory; (6) acquiring data and encrypting the data with the key; (7) sending data over the Internet to the drone information database; (8) in the alternative to sending data over the Internet, sending data to a portable interactive device for temporary storage; and (9) forwarding temporarily stored data from the portable interactive device to the drone information database. The reference numerals above refer to exemplary components.

Row (1) represents creation of a new account. A new account could take the form of a new subscriber 170. The subscriber 170 may log in via the portable interactive device 260. The new account may be dedicated to one particular drone 10 which will have a unique identifier. This information is stored in the drone information database and then transmitted to a third-party key server. The third-party key server creates a storage location for the new account and generates the key. Row (2) illustrates that the new account may log in at the portable interactive device. The new account is verified at the drone information database and at the key server. In row (3) the key server produces key information returned to the portable interactive device. User details are sent from the drone information database to the portable interactive device.

In the description in FIGS. 9, 10, and 11 reference numerals are not used. The names of the components describe particular structure and function. The data flow is not restricted to particular components.

In row (4) a new tag in a drone 10 will send information to the portable interactive device 260 via BLE. Information indicative of the content of the new tag is added to the drone information database. The key server adds the information and creates a new key. As seen in row (5) the key server sends the new key via the portable interactive device to memory in the secure processor 474 in the drone tag 410.

In operation, at row (6), data acquired is sent to the drone tag secure processor and is encrypted with the key and then stored in encrypted form. Row (7) illustrates stored encrypted data transmitted via the Internet to the drone information database. The data remains encrypted while in storage. As seen at row (8) data may be sent from the drone tag via BLE to the portable interactive device. As seen at row (9) data may be temporarily stored in the portable interactive device and then sent to the drone information database.

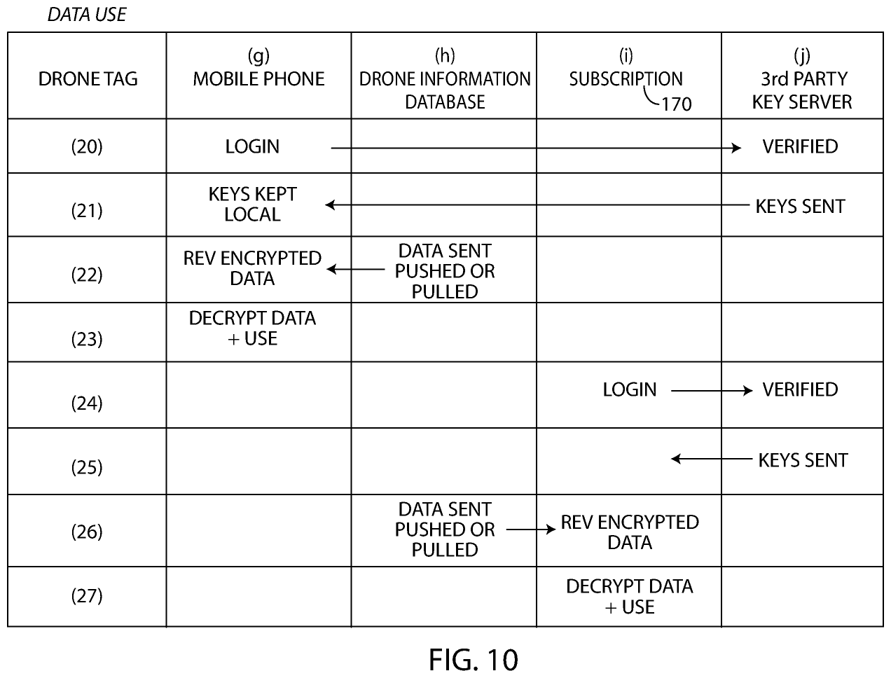

FIG. 10 illustrates the path of data in use. FIG. 10 comprises columns corresponding to data location as follows: (g) the portable interactive device; (h) the drone information database; (i) a subscriber; and (j) the third-party key server. Data paths are described in the following rows. Login is represented in row 20. Login information is sent from the portable interactive device to the key server. Keys are sent from the key server and securely stored in the portable interactive device, line 21. At line 22 data is pushed or pulled at the drone information database, and encrypted data is received at the portable interactive device. At line 23, data is decrypted and used by a device for which it is an input.

Line 24 represents login by a subscriber at cell 24. The key server verifies the subscriber and sends keys in protected form to the subscriber. At line 26, data is pushed or pulled with respect to the drone information database. The encrypted data is received by the subscriber. At cell 27 (i) data is decrypted and used by the subscriber.

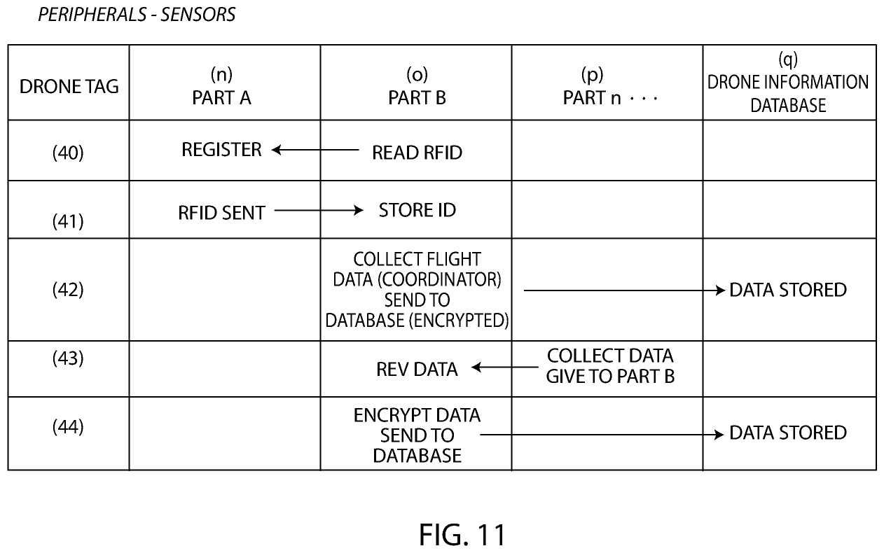

FIG. 11 represents data flow between the drone tag and the drone information database. Column (n) represents the RFID tag 410 column (o) represents the processor section 464 of the drone tag 410, column (p) represents part n, and column (q) represents the drone information database. Part n refers to sensors, transducers, and other components which collect or receive mission data. Data flow occurs at the following lines in the following descriptions. At cell 40 (o) an RFID number is read and registered in the RFID tag as seen in cell 40 (n). In line 41, an identification number in the RFID tag is read and stored by the processing section. At line 42 collected flight data is encrypted and sent in encrypted form to the drone information database. At line 43 data is collected and then received at the processing section. At line 44, the received data is encrypted and sent to the drone information database.

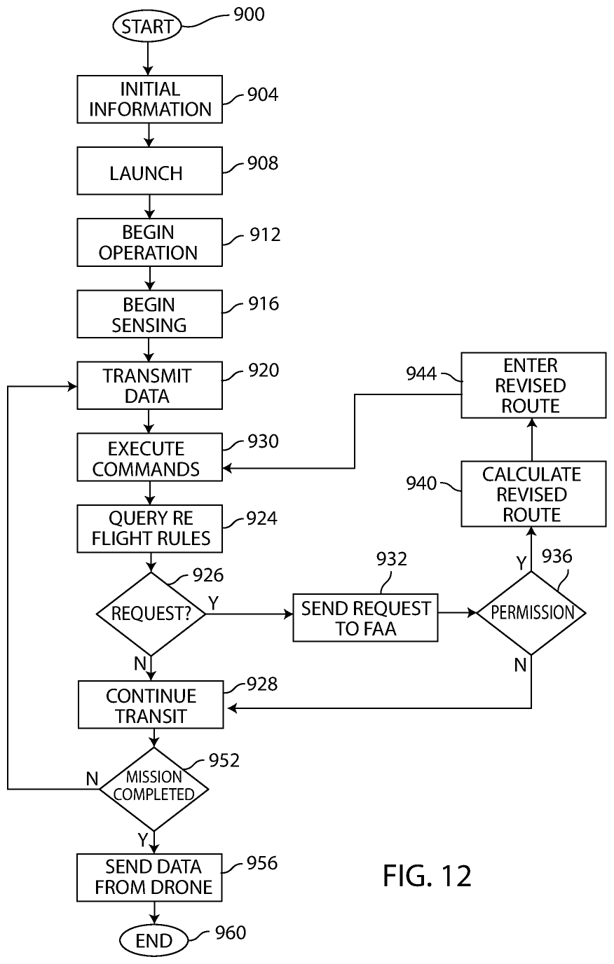

FIG. 12 is a flow chart which illustrates operation of the present system. Operations starts at block 900. At block 904, the drone services company 100 (FIG. 1) provides initial information to the drone 10. This initial information includes data to populate fields in the drone tag memory 428 (FIG. 3). Among the fields that are loaded are the management field 620 (FIG. 5), the configuration field 604 (FIG. 5), and the authorization field 602 (FIG. 5). At block 908 the drone 10 is launched and begins its ascent. At a programmed time, at block 912, operation begins. The accelerometers 442 (FIG. 3) begin updating a preprogrammed X-Y-Z position. Selected communications with the base station 114 (FIG. 1) and the portable interactive device 260 (FIG. 1) are also initiated.

At block 916, sensing operations begin. Depending on the assigned task, selected sensors in the sensor package 441 (FIG. 3) are activated to gather selected data. Various tasks hitherto unperformed in the prior art may be conducted. One task, for example, is determining the temperature profile at the altitude of 400 feet, the nominal limit for a drone's altitude. Geophysical parameters may be gathered. Video operations may be commanded. At block 920, transmission of data to the base station 114 and/or the portable interactive device 260 begins. Data may be gathered by the drone services company 100. Additionally, data may be provided to subscribers 170 (FIG. 1).

Operation proceeds to block 930 where the drone 10 continues to execute preprogrammed and received commands. Next at block 924, the drone tag processor 474 (FIG. 4) periodically queries the management field 620 (FIG. 5) as to whether an authorized exception to flight rules is requested. At block 926 it is determined if a request has been made. If no request is made, operation proceeds to block 928, where transit is continued in accordance with regulations, and a preprogrammed flight plan continues to be followed. If a rules exception authorization request is made, operation proceeds to block 932, where the request is made to an authority such as the FAA. In a situation in which an “online” decision may be provided in a matter of minutes, the drone 10 will continue on course until an answer is provided. At block 936 it is determined if permission is granted. If so, operation proceeds to block 940 where a revised route is calculated. At block 944 the revised route is entered in the operating field 616. Operation proceeds back to block 930 where travel along a mission route continues. At block 952, a determination is made as to whether the mission is completed. If not, operation returns to block 920 and the mission continues. If the mission is concluded, the drone 10 provides data in accordance with its instructions at block 956. At block 960, the routine is completed. Steps above may be executed in a different order or in parallel except where logically impossible.

The RFID tag element 420 is for purposes of inventory tracking and easy identification of the drone tag unit. The RFID interface is not utilized in the communication of any collected data or transmit/receive of command data.

Collected data and general command communication is preferably performed by interfaces, such as Cellular service, Bluetooth, ZigBee, UHF, and other protocols in existence or which may be developed in the future.

It is not essential to have all elements described above in a drone tag.

A basic core drone tag 410 would be comprised of the following:

RFID tag 420 for identification of the tag and inventory control;

Processor, RAM memory, and Flash Memory or other persistent storage included in the processors such as 474 and 476;

Radio Communications module, Bluetooth, cellular, ZigBee, UHF, and the like;

Accelerometers 442, at least one, but generally a plurality;

Encryption decryption capability;

Secure storage for encryption decryption key(s) which may also perform the encryption decryption;

Interface to allow additional devices to be connected to the drone tag 410 for purposes of providing additional types of data gathering such as temperature or proximity of other entities as by radar;

Circuit board, flexible or rigid; and

Optional replaceable or rechargeable batteries.

The present invention includes various operations. The operations of the present invention may be performed by integrated hardware components. Distributed discrete components are shown for ease in illustration. Field programmable gate arrays (FPGAs) could be used to provide processors. Those skilled in the art will recognize that many forms of communication may be provided in accordance with the present teachings. The present subject matter enables a comprehensive approach to providing useful, individualized data packages or command packages to many different stakeholders having diverse data requirements.

1. A system providing secure communication, data generation and data transfer, and tracking between a drone and a plurality of interactive entities comprising:
a. a drone tag for mounting in a drone, said drone tag comprising a location memory and processors;
b. one entity comprising a base station including a transmitter and a receiver tuned to communicate with an RFID tag, said base station having a base station server including an identity and encryption tag information database including locations each storing a drone identifier and locations each storing encryption tag information;
c. a drone tag for mounting in said unmanned aerial vehicle, said drone tag comprising an RFID tag, said RFID tag including an identifier section, a processing section, an identity register, and an encryption processor;
d. said drone tag further comprising a transmitter and a receiver, said drone tag further comprised in operating hardware for commanding and performing all functions of the drone;
e. said drone tag further comprising condition-responsive sensors;
f. said drone tag receiving data and providing data to a memory via said encryption processor; and
g. said encryption processor exporting a public key to said base station.

2. The system according to claim 1 comprising a selection circuit for resolving data received from said drone tag into separate fields of drone information, said selection circuit comprising a matrix defining fields of drone information for one said entity,

3. The system according to claim 2 wherein said drone tag further comprises a location memory for storing initial GPS coordinates and wherein said condition-responsive sensors comprise accelerometers coupled to update a current position of said drone in said location memory.

4. The system according to claim 3 wherein said drone tag comprises a flight information recorder storing preselected parameters for availability to external entities.

5. The system according to claim 4 wherein said base station is coupled for communication with other entities.

6. The system according to claim 5 comprising a timing circuit coupled to initiate transmission of the flight information at at least one time during a drone flight.

7. The system according to claim 6 wherein said drone tag comprises a cellular module for communicating with a portable interactive device.

8. The system according to claim 6 wherein said drone tag further comprises an encryption processor maintaining encryption keys.

9. The system according to claim 1 wherein said drone tag is a polymer substrate having adhesive on one side.

10. A method for secure communication, data generation and data transfer, and monitoring between a drone and a plurality of interactive entities comprising:
a. providing a drone tag located on the unmanned aerial vehicle, said drone tag comprising microprocessors and memory, the drone tag including an RFID tag;
b. providing initial GPS coordinates to the drone tag;
c. measuring current parameters with sensors and updating condition-responsive data stored in the drone tag during flight;
d. forming a data package comprising information stored in the drone tag;
e. reporting data including ID, coordinates, and condition-responsive information to the base station in response to commands;
f. storing a set of constraints in the RFID drone tag and selectively updating the set of constraints;
g. providing selected data fields and creating sets of selected fields of data, each set of data being associated with a type of entity; and
h. transmitting sets of data to the base station server.

11. The method according to claim 10 wherein providing the drone tag comprises inclusion in drone electronics of encryption and decryption microprocessors and further wherein storing flight information comprises storing encrypted data.

12. The method according to claim 11 further comprising issuing blocks of drone tag IDs by the base station whereby a manufacturer may assign individual drone ID tags to individual respective drones.

13. The method according to claim 11 further comprising performing a drone tag verification routine between the RFID drone tag and the base station server.

14. The method according to claim 13 comprising communicating from the base station to a plurality of individual drone operators each associated with a drone ID tag, receiving requests from the operators for permission to change flight parameters, forwarding the requests to a responsible authority, and returning any authorization to an operator.

15. The method according to claim 14 wherein forwarding the request comprises translating the request into a format for receipt by a cognizant governmental authority and monitoring communication and forwarding a response to the drone operator and wherein forwarding an authorization comprises sending flight commands to the drone.

16. The method according to claim 15 wherein said base station server interacts with a plurality of drone operating companies to provide real time flight information to each drone operating company for use by said drone operating company in accordance with its own algorithms.

17. The method according to claim 11 further comprising communicating with entities outside of the drone via a portable interactive device before and after a drone flight.

18. A method for interfacing entities within a drone operating system, the entities including a base station and subscribers comprising:
a. establishing a group of subscribers;
b. establishing at least one class of subscribers;
c. assigning each subscriber to at least one class;
d. associating a drone tag with a corresponding subscriber;
e. receiving flight data from a drone;
f. providing an input application program interface (API);
g. providing data via the API to each subscriber;
h. reporting to subscribers selective sets of flight information;
i. providing a drone tag located on the unmanned aerial vehicle, said drone tag comprising microprocessors and memory and at least one each of transmitter and at least one each of receiver;
j. forming a data package comprising information stored in the drone tag; and
k. reporting data including ID, coordinates, and condition-responsive information to the base station server in response to commands.

19. The method according to claim 18 further comprising storing a flight plan in said RFID drone tag and selectively updating the flight plan.

20. The method according to claim 18 further comprising interfacing with subscribers via an Internet of things (IOT) message forwarder.

21. The method according to claim 18 further comprising transmitting data to the drone from the base station.

22. The method according to claim 18 further comprising transmitting flight commands to a drone associated with a particular subscriber.
